(19) United States
(12) Patent Application Publication
(10) Pub. No.: US 2016/0323433 A1
(43) Pub. Date: Nov. 3, 2016

(54) SYSTEMS AND METHODS FOR CONNECTING A MOBILE DEVICE TO A COMMUNICATION SYSTEM

(71) Applicant: SONIFI Solutions, Inc., Sioux Falls, SD (US)

(72) Inventors: Andy Loren Anderson, Sioux Falls, SD (US); Sridhar Guthula, Fremont, CA (US); Derin M. Zerr, Kahului, HI (US); Joel Walter Zdepski, Mountain View, CA (US)

(21) Appl. No.: 15/144,492

(22) Filed: May 2, 2016

Related U.S. Application Data
(60) Provisional application No. 62/155,953, filed on May 1, 2015.

(51) Int. Cl. H04M 1/725; G06K 19/06; H04W 48/04; G06K 19/07

(52) U.S. Cl. CPC H04M 1/7253; G06K 19/0727; G06K 19/06009; H04M 1/72572; H04W 48/04

(57) ABSTRACT

Methods and systems for enabling a function based on identifying information for a mobile device are provided. The identifying information can include location information, and is provided from a communication device or identification tag. The mobile device provides the identifying information to a system authority. The mobile device can also provide additional identifying information to the system authority. The system authority can then authorize a command and control or a content delivery operation.

### CROSS-REFERENCE TO RELATED APPLICATIONS

This application claims the benefit of U.S. Provisional Patent Application Ser. No. 62/155,953, filed May 1, 2015, the entire disclosure of which is hereby incorporated herein by reference.

### FIELD

Systems and methods for connecting a mobile device to a communication system are provided.

### BACKGROUND

Guests of hospitality facilities often carry mobile devices. These mobile devices, such as smart phones, can be used for a variety of functions. For example, in addition to supporting voice communications, mobile devices are often capable of supporting textual communications, browsing the Internet, and running various apps or applications. Increasingly, mobile devices are also being used as a store of credentials associated with the user, enabling the mobile device to perform other functions, such as a digital wallet function. In addition, users desire the ability to access content, such as movies, and to control entertainment system functions of installed systems using their mobile devices.

Hospitality facilities, including but not limited to hotels, can offer a variety of amenities to guests. For example, within a guest room, various entertainment devices, such as but not limited to televisions and on demand programming, can be provided. In order to enhance the guest experience, the control of and interaction with various hotel amenities can be enhanced by pairing a mobile device carried by the guest to those amenities. For example, techniques have been developed that allow a mobile device to be used as a remote control with respect to televisions in guest rooms. As another example, mobile devices can be used to access content, such as movies, and to display that content. However, operatively connecting a mobile device to a system to allow control of the system and access to content has been difficult or even impossible using conventional systems and techniques. In addition, conventional systems have been unable to comply with requirements imposed by licensors of content regarding limitations on where or under what conditions content can be delivered. Accordingly, the delivery of content, such as on demand programming, to mobile devices has been constrained.

### SUMMARY

Embodiments of the present disclosure are directed to systems and methods for supporting or enabling the interoperability or pairing of mobile devices with hospitality facility entertainment systems, communication systems, and amenities (hereinafter referred to simply as communication systems). A communication system as disclosed herein can include a communication device that is operable to communicate with a mobile device in the proximity of the communication device in order to establish at least one of a command-and-control or a content sharing relationship between output devices, entertainment systems, communication networks, servers or other systems or devices associated with the communication device and the mobile device. In accordance with at least some embodiments of the present disclosure, the communication device may be provided as a standalone component, or as part of another device, such as but not limited to a television, set top box, remote control, network access point or the like.

The communication device can operate to provide the mobile device with an identification signal that includes an identifier or code that can be used in connection with establishing the command-and-control relationship. For example, a code can be provided as part of a discrete communication to the mobile device. The communication device can establish a communication link with the mobile device automatically, in response to detecting the presence of the mobile device. Alternatively or in addition, a communication link can be established after a request to establish a communication link has been received, for example as a result of input from a user entered through the communication device or the mobile device. After establishing the communication link, the communication device can provide the identifier to the mobile device as part of an identification signal.

The mobile device can in turn send the identifier to a system authority. In addition to indicating that the mobile device has communicated with a communication device, the identifier can provide information identifying devices or equipment for which a command-and-control relationship is to be established with the mobile device. This information identifying the appropriate equipment can be in various forms. For example, the information can indicate the room or area where the mobile device is located. As another example, the information can identify a particular television, set top box, access point or other equipment. Moreover, the identifying information can be relayed to the mobile device through an intermediate device. For instance, information identifying a particular television can be sent to a remote control unit each time the remote control unit is used to control that television. The remote can in turn pass on the information identifying the television to the mobile device if that remote is used to provide identifying information to the mobile device.

The communication between the communication system equipment and the mobile device can be carried out by any of various means and protocols. For example, infrared, acoustic, optical, radio frequency, coordinated acceleration, and contact can all be used to communicate information used for establishing the command-and-control relationship. Specific examples of communications systems that can be used include, but are not limited to, near field communications, image based systems, infrared links, Bluetooth, and Wi-Fi. Other examples include the use of accelerometers in one or more devices, alone or in combination with location information and timing information.

In order to complete authorization and enable control and communication with the communication system, the mobile device may be required to pass the authorization identifier, alone or with additional identification information, to a system authority. Examples of additional identification information include, but are not limited to the name of the user or guest, a loyalty program identifier, a credit card, coupon code, a promotional code, a telephone number, MAC address or other identifier associated with the mobile device itself, a loyalty membership account number, subscription account identifier, or any other personal identification number associated with the user of the mobile device, or the like. One or more such identifiers in various combinations may be required. In addition, location information obtained by the mobile device from a communication system component, or from the mobile device itself, may be required. In accordance with at least some embodiments, the mobile device may be required to establish a separate communication link with the hospitality facility over which the additional identification information is provided. In addition, information from a property management system may be required in order to verify that a requested operation is authorized. Any additional identification information which is required can be submitted through operation of a specialized application or app that enables a connection with the system authority, a web-based interface, or the like.

Additional features and advantages of embodiments of the present disclosure will become more readily apparent from the following description, particularly when taken together with the accompanying drawings.

### BRIEF DESCRIPTION OF THE DRAWINGS

FIG. 1 is a block diagram depicting components of a system in accordance with embodiments of the present disclosure;

FIG. 2 is a block diagram depicting components of a communication device, a server device, and a mobile device in accordance with embodiments of the present disclosure; and

FIG. 3 is a flowchart depicting aspects of a method in accordance with embodiments of the present disclosure.

### DETAILED DESCRIPTION

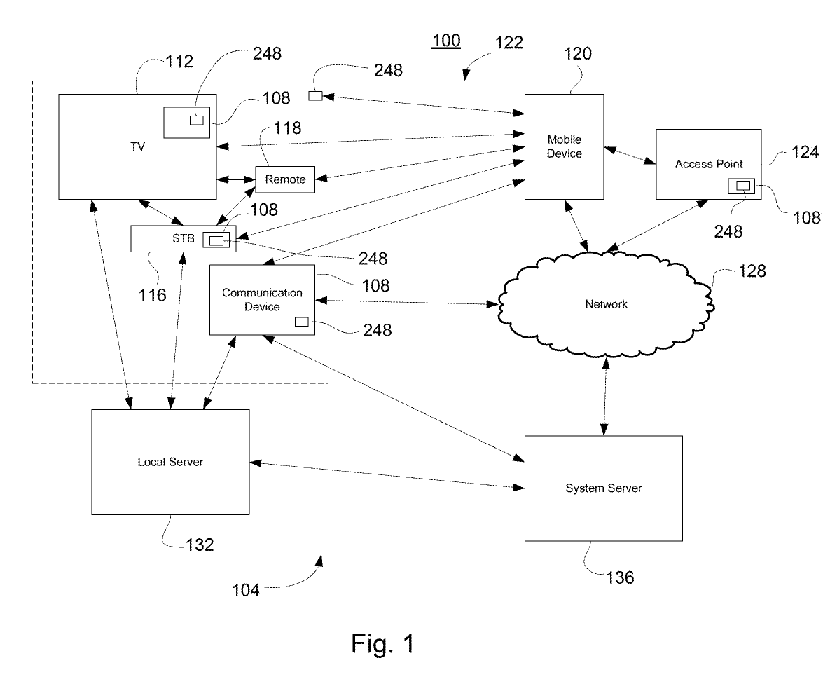

FIG. 1 is a block diagram depicting components of a communication system 100 in accordance with embodiments of the present disclosure. As an example, but without limitation, the communication system 100 can be associated with a facility that provides lodging or other services to a transient consumer, such as a hotel, lodge, hospital, bar, restaurant, convention center, assisted living facility, school dormitory, cruise ship, bus, airplane, or any other facility with a communication system 100 as described herein. The communication system 100 generally includes a number of communication system components 104 that are associated with the facility. A communication system device 108 and an output device 112, such as a television, can be included in the system components 104. Alternatively or in addition, the system components 104 can include a set top box 116. As can be appreciated by one of skill in the art after consideration of the present disclosure, a set top box 116 can provide connectivity, tuning, recording, or other functions. The communication system 100 can also include one or more remote control devices 118, for example for controlling the television 112 and the set top box 116. The communication device 108 is operable to support one or two-way communications with a mobile device 120. The communication device 108 can be implemented as a standalone communication device 108, or the communication device 108 can be provided as part of another device, such as but not limited to a television 112, a set top box 116, a Wi-Fi or other network access point 124, or a remote control device 118. Moreover, multiple communication devices 108 can be included as a system component 104.

At least some of the system components 104 are associated with a known location within the facility. Moreover, a system component 104 can include an identification tag 248. As described in more detail elsewhere herein, an identification tag 248 can provide an identifier 250 in the form of an identification signal or code 250 that can be used to determine a location of a mobile device 120.

The system 100 also includes the mobile device 120. Typically, the mobile device 120 is a smart phone, tablet computer, laptop, or other portable device that is capable of supporting communications between the mobile device 120 and other devices or systems, including but not limited to a communication device 108. In addition, the mobile device 120 can be associated with a unique identifier. The unique identifier can include a device serial number, telephone number, or other identifier associated with the mobile device 120 itself. Alternatively or in addition, the unique identifier can include a loyalty program membership number, subscription number, personal identification number, or other identifier associated with a user of the mobile device 120. The mobile device 120 can support communications using communication channels 122 established directly with communication system components 104, or established over one or more networks 128. As examples, such networks can include networks that connect to the mobile device 120 wirelessly, such as a cellular communication network, a satellite communication network, a Wi-Fi network, or a Bluetooth network. As can be appreciated by one of skill in the art after consideration of the present disclosure, such wireless connections can provide connectivity to the public switched telephony network, the Internet, or private networks. In addition to network connections, the mobile device 120 can support more limited connections, such as direct connections. For example, the mobile device 120 can include support for near field communications, infrared communications, radio-frequency identification, and the like.

The mobile device 120 can communicate over communication networks through connections established between the mobile device 120 and an access point 124, such as but not limited to a wireless access point, for example a Wi-Fi access point provided as part of a hospitality facility, or an access point 124 in the form of a cellular base station, satellite, or other communication system node. Accordingly, an access point 124 need not be limited to communication system components 104 located in the facility. The access point 124 can connect the mobile device 120 to a local area network and to a local server 132, a system server 136 and/or to a larger communication network, such as but not limited to the Internet 128. In accordance with at least some embodiments, an access point 124 can include a communication device 108.

One or more server devices, such as a local server 132 and/or a system server 136 are also included in the system 100. In general, a local server 132 is located in the vicinity of the room or other area within the hotel or other facility in which the communication system components 104 are located. A system server 136 is typically at a location remote from the facility, such as at a central administration location or in the cloud. Moreover, a system server 136 may provide services to a plurality of hospitality facilities. In general, a server device 132 or 136 is a computer that provides system authority services, and can communicate with room components 104 via the Internet, a private network, and/or dedicated connections. The services provided can include television programming, both broadcast and on demand, and programming and features associated with a particular hospitality facility. In addition, the particular content available can be determined, at least in part, based on an identification of the mobile device 120 and/or the associated user credentials. The server device 132 or 136 can also be placed in communication with a mobile device 120 via the Internet 128, the public switched telephony network, a private network, or the like. The server devices 132 or 136 can be in communication with communication system components 104 through one or more communication channels that are established separately from the mobile device 120. In addition, the server device 132 or 136 can be in communication with or receive information from a communication system component 104, such as a communication device 108 or an identifier tag 248 through the mobile device 120.

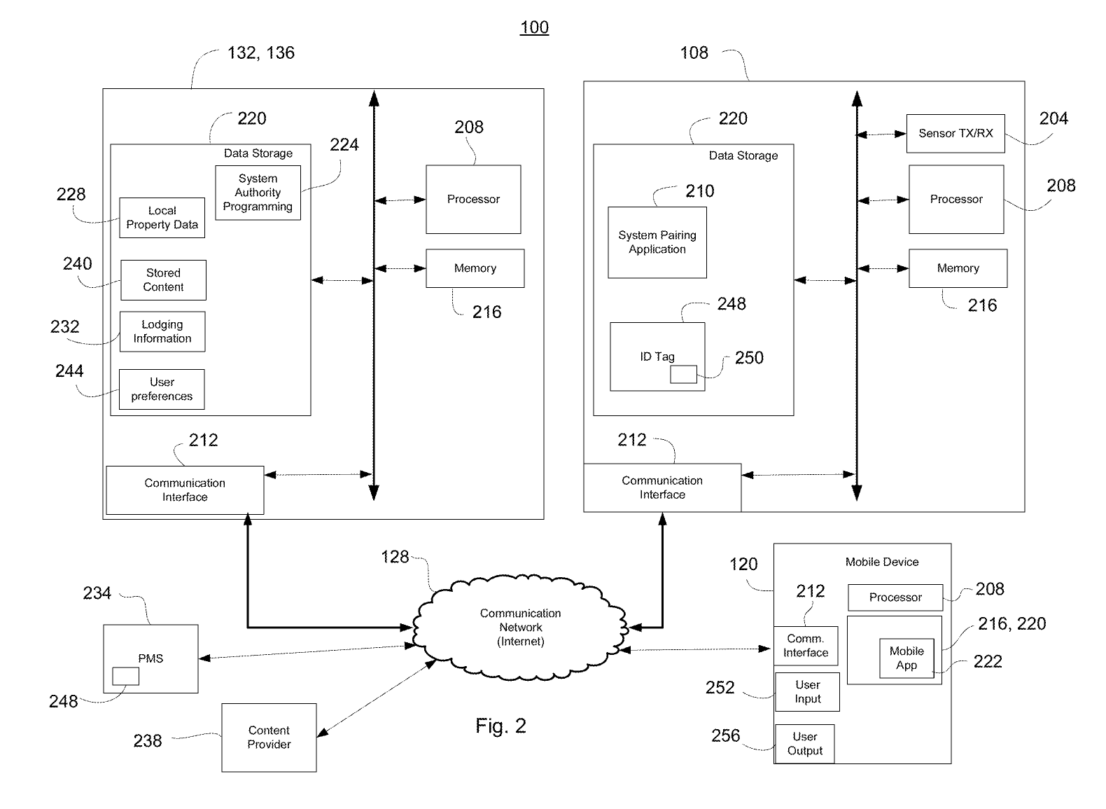

FIG. 2 is a block diagram depicting components of a communication device 108 that is implemented as a standalone device or as part of another communication system component 104, a mobile device 120, and a server device 132, 136 included in a system 100 in accordance with embodiments of the present disclosure. In addition, a property management system (PMS) 234 and a content provider system 238 are depicted.

In general, the communication device 108 includes a sensor transmitter/receiver 204 connected to a processor 208. The sensor transmitter/receiver 204 operates to transmit an identification signal containing an identifier 250 to a mobile device 120. The identifier 250 can be obtained or derived from an identification (ID) tag or identifier 248 associated with a particular communication device 108 and/or location. The information included in the identification tag 248 can be delivered to a mobile device 120 through an intermediate communication system component 104, or directly, using any of a number of available technologies. For example, the identification tag 248 can be provided as a sequence of data or code that is stored in data storage 220 associated with the communication device 108, and that is used by the communication device 108, an output device 112, or other communication system component 104, alone or in combination. When the identification tag 248 provides a sequence of stored data or code, the identifier 250 can be displayed by an output device 112, such as a dynamic display, as a video sequence, alphanumeric code, or barcode. Alternatively or in addition, the identifier 250 can be output as an audio sequence played through an output device comprising a speaker. As yet another example, the identifier 250 can be transmitted electronically as an encoded signal.

In accordance with still other embodiments of the present disclosure, the identification tag 248 can be in the form of a static, human readable label, such as a printed alphanumeric code or a radio frequency identification RFID tag, or a machine readable label, such as a barcode or QR code, or any other form capable of storing and/or providing an identifier 250 to a mobile device, that does require any active components, such as processors or memory,

Moreover, the identification tag 248 can operate to provide an identification signal containing or comprising an identifier 250 continuously, on its own initiative, in response to a request from an app 222 running on the mobile device 120, or in response to some other external stimulus. In accordance with at least some embodiments of the present disclosure, a communication of an identifier 250 from an identification tag 248 to a mobile device 120 is made directly, rather than through a communication network, such as where the identification tag 248 is in the form of an RFID tag, a static barcode, a static label, or an electronically displayed label. As can be appreciated by one of skill in the art after consideration of the present disclosure, the particular communication interface or 212 or input 252 of the mobile device 120 that is used to receive the identifier 250 can depend on the form in which the identifier 250 is delivered by the communication system 104.

Accordingly, the transmitted identification signal can be a signal that is actively generated by a system pairing application 210 running on the communication device 108. In accordance with at least some embodiments of the present disclosure, the identification signal can be generated by the system pairing application 210 in response to the receipt of an interrogation signal sent by the mobile device 120. In accordance with still other embodiments, the identification tag 248 can be provided to the system pairing application 210 of a communication device 108 from another device. For example, the communication device 108 can be provided with the identification signal 250 from a television 112, a set top box 116, a local server 132, or a system server 136. Moreover, an identifier 250 that is provided to the communication device 108 from another device can be delivered to the communication device 108 through an intermediate device. As a specific example, but without limitation, a system server 136 can generate a sequence of data comprising an identifier 250, which it then provides to a television 112, which in turn provides the identifier 250 as part of an identification signal to a communication device 108 in the form of a remote control unit 118. The remote control unit 118 in turn provides the identifier 250 to the mobile device 120. Accordingly, a communication device 108 can have components and/or functions that are distributed across multiple devices. For example, a server 132 or 136 can provide the identification signal to a television 112 or set top box 116, which delivers the identification signal to a remote control device 118, which in turn delivers the identification signal to the mobile device 120.

The mobile device 120 can comprise a smart phone, or other mobile device having communication capabilities, and the ability to carry a unique identifier. In an exemplary embodiment, the mobile device 120 includes a processor 208, memory 216 and/or data storage 220. A mobile app or application 222 can be stored in the memory 216 and/or data storage 220. The mobile app 222 can function to provide an identifier 250, such as an identifier 250 received as part of an identification signal from a communication device 108, to the system authority application or programming 224 running on a local 132 or system 136 server. The mobile device 120 also includes a communication interface 212. In a typical embodiment, the communication interface 212 of a mobile device 120 may comprise a set of different communication interfaces 212 capable of communications over different networks or communication systems. For example, a communication interface 212 can include a cellular telephony communication interface, a satellite telephony communication interface, a Wi-Fi interface, a Bluetooth interface, a near field communications interface, an infrared interface, etc. One or more inputs 252 and one or more outputs 256 are also generally included. Examples of inputs 252 include a touch screen display, microphone, and camera. Examples of outputs 256 include a video display and a speaker. As can be appreciated by one of skill in the art after consideration of the present disclosure, various components of the mobile device 120 (and other system 100 components) can perform multiple functions.

A signal embodying the identifier 250 may be passed to the mobile device 120 using various communication channels. For example, the identifier 250 may be transmitted to the mobile device 120 from the communication device 108 as a near field communications (NFC) signal, a Bluetooth communications signal, an RFID signal, an acoustic signal, a visible optical signal, an infrared (IR) signal, or the like. Alternatively or in addition, the user may be required to enter the identifier 250 that is provided from the identification tag 248 in the input 252. Accordingly, in at least some embodiments the identifier 250 may be code, such as an alphanumeric code, that can be read copied by a human. However, such a human readable code, when used, does not inherently provide location information. Instead, the identifier 250 location information is only available after the identifier 250 is applied to a table that is indexed by the identifier 250, or some other machine implemented operation is performed, to determine a location associated with the identifier 250.

The identifier 250 can be received by firmware or software running in the processor 208 of the mobile device 120, and sent to a server device 132, 136 over a network or direct connection via a communication interface 212. As examples, a mobile device 120 command and control or mobile app or application 222 that interacts with a server device 132, 136 may be implemented as firmware or software stored in memory 216 and/or data storage 220 associated with the mobile device 120. In addition to the received identification signal, other information can be sent to the server device 132, 136, such as information identifying the mobile device 120 or a user of the mobile device 120. Information identifying and authorizing use of or access to a source of content can also be provided.

The server device 132, 136 generally includes a processor 208, memory 216, data storage 220, and a communication interface 212. The server device 132, 136 operates as a system authority, and controls services that are enabled in response to detecting the presence of an identified mobile device 120. The server device 132, 136 can include system authority programming 224. For example, as discussed in greater detail elsewhere herein, the server device 132, 136 can enable control of selected hospitality facility entertainment devices in response to receiving the identification tag 248 and any other information from the mobile device 120. Control that is granted can be with respect to devices within a particular guest room associated with the user of the mobile device 120. Accordingly, the enablement of features can require the association of a user's mobile device 120 with an assigned room. Accordingly, the system authority 132, 136 can store lodging information 232, or can have access to lodging information 232 maintained by a property management system 234, to verify that the mobile device 120 is associated with a guest of the facility or other authorized user. User specific selections can be stored as user preferences 236, which can be applied once a pairing is completed. In addition, the server device 132, 136 can store or have access to content 240 available from a content provider 238, such as a subscription or on-demand video service located in the cloud.

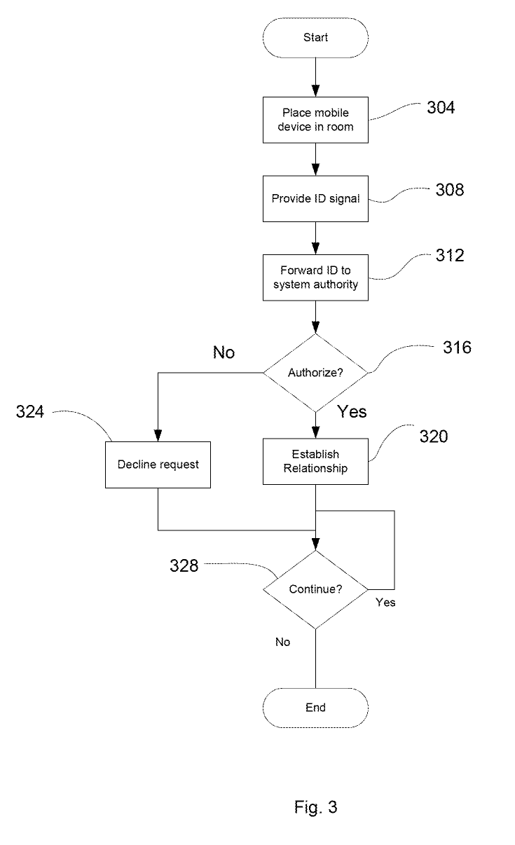

FIG. 3 is a flowchart depicting aspects of a method for pairing or connecting a mobile device 120 to communication system components 104 to enable command and control of output device 112 features, and/or to display content on a mobile device 120 or other communication system 104 component, in accordance with embodiments of the present disclosure. Initially, at step 304, a mobile device 120 is brought into proximity with a communication device 108. As an example, but without limitation, bringing a mobile device 120 into proximity with the communication device 108 can include a guest carrying a mobile device 120 into a guest room at a hotel or other hospitality facility. Next, an identification signal is provided from the communication device 108 to the mobile device 120 (step 308). The identification signal can transmit an identifier 250 that is stored or otherwise held locally as or within an identification tag 248 at a communication device 108, or that is stored on or generated by another communication system device, such as by a server device 132 or 136 operatively connected to a communication device 108. In accordance with embodiments of the present disclosure, the identifier 250 can be a static or dynamically generated code that is associated with a particular room or area of a hospitality facility. In accordance with other embodiments, an identifier 250 can be generated by a system authority, such as a server device 132 or 136 in response to a request to establish a command-and-control relationship between a mobile device 120 and room components 104, such as entertainment devices associated with a guest room, and delivered to a communication system device 104 in that room.

Providing the identification signal to the mobile device 120 can be performed automatically, for example as a result of the proximity between the communication device 108 and the mobile device 120. Alternatively or in addition, an identification signal containing an identifier 250 can be sent in response to a request from a user. For example, a user can operate a device 112, 116, 118 associated with the hospitality facility entertainment system to cause an identification signal that includes an identifier 250 to be generated and/or presented. As an example, but without limitation, a user can control a television 112 to display an identifier 250. In general, the identifier 250 included in an identification signal is used by the system 100 to determine or confirm a location of a mobile device 120 and/or the communication system components 104 for which a pairing relationship with a mobile device 120 is being requested.

The identification signal can be provided as a static image displayed by a television 112, or as a label comprising an identification tag 248 that is affixed to a communication system component 104 or a fixture in a room. An identifier 250 in the form of a static image can be captured by an input 252 of the mobile device 120, for example where the image is in the form of a barcode, QR code, graphic, photograph, or any other image that can be uniquely identified and used for identification purposes. As a further example, an image displayed by a television or by a label can be in the form of an alphanumeric value that can be entered into the mobile device 120 manually. As other examples, an identifier 250 can be transmitted as an optical signal, such as an infrared signal, video signal, or other signal that is presented and acquired by an input 252 of the mobile device 120 over time. As still further examples, an identification signal can be in the form of an audible signal, such as a song, sequence of tones, or other human perceptible, ultrasonic, or other noise generated by a speaker of a room component 104 and received at a microphone of a mobile device 120. In accordance with still other embodiments, an identifier 250 can be transmitted using radio waves. For example, an identification signal can be transmitted from a communication device 108 to a mobile device 120 as part of a near field communication, Bluetooth communication, Wi-Fi communication, or other wireless communication protocol.

After receiving an identification signal containing an identifier 250, the mobile device 120 can forward the received identifier to a system authority 132 or 136 (step 312). In accordance with at least some embodiments of the present disclosure, the mobile device 120 can run an application or app 222 stored on or accessible to the mobile device 120 that receives the identifier from the communication device 108 and that automatically establishes a communication link to the server device 132 or 136 in order to deliver the identifier to that system authority. In addition, in accordance with at least some embodiments of the present disclosure, the mobile device 120 can also provide additional information to the system authority, such as information identifying a particular mobile device 120, the user of a mobile device, subscription credentials, or the like.

Upon receiving the identifier and any other information from the mobile device 120, the system authority, such as may be implemented by a server device 132 or 136 executing system authority programming 224, determines whether the request for a command-and-control relationship and/or content delivery should be authorized (step 316). For example, the system authority can determine whether the identifier is a valid code, whether the code is assigned associated with an authorized or appropriate user or mobile device 120, etc., and whether the mobile device 120 is in an area in which the requested command and control or content delivery is authorized. This authorization can be performed by comparing the identifier 250 to a table of information regarding the valid locations and/or valid communication system components associated with the identifier 250. In addition to the identifier 250, authorization may require the receipt of lodging 232 or other information confirming that the mobile device 120 is associated with a guest or other authorized user. Where lodging information is required, that information may be obtained from a property management system 234. In accordance with still other embodiments of the present disclosure, authorization may require that the mobile device 120 provide location information determined by a global positioning system receiver incorporated in the mobile device 120.

In response to determining that the command-and-control relationship or content delivery should be authorized, a pairing relationship between the mobile device 120 and the communication system devices 104 is established (step 320). Establishing a relationship can include providing the communication system devices 104 with instructions to accept commands from the paired mobile device 120 for a predetermined period of time, until the instructions are revoked, or until the relationship is otherwise terminated. Such commands can be sent directly from the mobile device 120 to the room components 104, or can be routed through other components, such as a server device 132 or 136. Examples of command and control operations that can be performed include accessing program guides, selecting programming from the programming guide, controlling volume and other output characteristics, and the like. Examples of content that can be delivered to a mobile device in accordance with embodiments of the present disclosure includes content that is licensed or otherwise made available under terms that include playing the content in a prescribed location.

If the system authority determines that the command and control relationship should not be authorized, a message can be sent to the mobile device 120 indicating that the request has been declined (step 324), or the request can simply be ignored. After granting a requested command and control, content delivery, or other relationship, a determination can be made as to whether the relationship should be continued (step 328). For example, if the user or a system administrator terminates the relationship, or if it is determined that the mobile device 120 has been moved from a location in which the relationship is authorized, the relationship can be discontinued. If the relationship is to be discontinued, or if a request was not granted, the process can end.

A system 100 as described herein can be provided and operated in various contexts. These include hotel rooms having communication system 104 components, such as a communication device 108, a television 112, a STB box 116, a remote control 118, or an access point 124, where at least one of the communication system components includes or is associated with an identification tag 248 that is operable to provide location information that can be delivered to the mobile device 120. Other examples of facilities in connection with which a communication system 100 as described herein can be implemented include lodges, hospitals, bars, restaurants, convention centers, assisted living facilities, school dormitories, cruise ships, buses, airplanes, or any other facility. Functions that the mobile device 120 can perform after a successful authentication that are in addition or alternates to command and control of an in-room entertainment system or delivery of content can include control of a juke box, projector, HVAC system, lighting control, door lock, or the like.

The following are non-limiting examples of different communication system 100 configurations and operations in accordance with embodiments of the present disclosure:

### Example 1

In this example, the communication system components 104 are located within a facility comprising a hotel, and the mobile device 120 is carried by a user who is a guest of the hotel. The communication system components 104 can include one or more communication devices 108 and a plurality of access points 124. The communication system components 104 can each be associated with a different identification tag 248, where the different identification tags 248 provide different identifiers 250. A user of a mobile device 120 can initiate a command-and-control, and a content delivery session by opening an app 222 on the mobile device 120.

Before or at the time the app 222 is opened, communication between the mobile device 120 and at least some of the communication system components 104 can be initiated. As an example, communication between a communication device 108 and the mobile device 120 can include an image capture operation performed by an input device 252 in the form of a camera included as part of the mobile device 120. More particularly, the image capture operation can include taking a picture of an identification code 250 displayed by an output device 112 in the form of a television that is located in the guest's room and that incorporates or is connected to the communication device 108. As a further example, communication between an access point 124 and the mobile device 120 can include establishing a wireless, such as a Wi-Fi, connection between the access point 124 and the mobile device 120, and providing an identifier 250 to the mobile device 120 over the wireless connection or communication channel.

A request to initiate the command-and-control relationship and content sharing operation is sent from the app 222 on the mobile device 120 to a system authority, implemented by a server system 132 or 136. In particular, the app 222 utilizes a communication channel established by the communication interface 212 of the mobile device 120 to contact the system authority. The communication channel can, for example, be established over a cellular telephone network, or through a Wi-Fi connection provided by an access point 124. The request can include the identification codes 250 provided by the communication system components 104.

In response to receiving the request, the system authority can validate the request. Validating the request can include verifying that the mobile device 120 is in a location in which the requested command-and-control and content delivery operations are authorized. For instance, the system authority can verify that the mobile device 120 is located in the guest's room, or other area of the facility in which the guest is authorized to interface with communication system components 104 and/or receive content. The location information used by the system authority to make the determination can be in the form of the identification code 250, which can be associated with a predetermined location by a table stored in or accessible to the server system 132 or 136. In addition, the location information can be determined from the set of communication devices 108 with which the mobile device 120 is in communication. For instance, a mobile device 120 that is in communication with a particular set of access points 124, each of which has a known location and a known coverage area, can be used to determine the location of the mobile device 120. Validating the request can also include obtaining information from a property management system (PMS) 234, to verify that the user of the mobile device 120 is an authorized guest of the facility containing the communication system components 104, and is further authorized to perform the requested operations and access the requested content.

If the validations are successfully completed, the server device 132 or 136 operating as the system authority can send a signal to the communication system components 104 in the user's room to accept command-and-control signals provided by the mobile device 120. Alternatively or in addition, commands from the mobile device 120 can be sent to the server device 132 or 136, and from there can be routed to the pertinent communication system components 104. In addition, the system authority can authorize the delivery of content to the mobile device 120 and/or to the output device 118 in the room. The content can be provided from server system 132 or 136, or from a another system or device, such as a storage system provided at the site of the communication system components 104, or from an external content provider 238, for instance located in the cloud. The command-and-control and content delivery operations can be terminated if the mobile device 120 is removed from the authorized location, if the guest associated with the mobile device 120 checks out from the hotel, or in response to command entered by the guest or a system administrator.

### Example 2

In this example, which like the foregoing example can be implemented within a hotel, the communication system components 104 may be in communication with a server system 132 or 136 operating as a system authority. However here the communication system 100 does not support control of an output device 112 included in the communication system components 104 by the mobile device 120. In such an embodiment, the system authority can perform location validation and guest validation operations as described in the previous example. In response to a successful validation, the delivery of content to the mobile device 120 can be authorized. The content can be delivered from a server system 132 or 136, or from another system or device, such as a storage system provided at a side of the communication system components, 104, or from an external content provider 238, for instance located in the cloud. The command-and-control and content delivery operations can be terminated if the mobile device 120 is removed from the authorized location, if the guest associated with the mobile device 120 checks out from the hotel, or in response to command entered by the guest or a system administrator.

### Example 3

This example can also be implemented within a hotel. However, the communication system components 104 are not in communication with a server system 132 or 136 operating as a system authority. In addition, the mobile device 120 does not establish a two-way communication link with a communication system component 104. Instead, the mobile device 120 can simply receive an identifier 250 from one or more communication system components 104. For instance, the mobile device 120 can receive the identifier 250 in the form of a code read from an identification tag 248 in a guest room. The mobile device can, through execution of the app 222, provide the identifier 250 to the system authority over a communication link established over a wide area network, such as a cellular telephone network. The system authority can then determine the location of the mobile device 120 from the identifier or identifiers 250 received from the mobile device 120. In response to determining that the location of the mobile device 120 corresponds to a location at which the delivery of requested content is authorized, the delivery of that content, for example from a server 132 or 136, or from a content provider 238, can be initiated. In addition, the system authority can, before initiating the delivery of content, receive payment information or credentials from the mobile device 120 to enable the delivery of the content. Accordingly, such embodiments can be implemented in hotels or other facilities that incorporate relatively unsophisticated on-premises communications system components 104, and without requiring that the communication system components 104 can be in communication with a system authority.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described hereinabove are further intended to explain the best mode presently known of practicing the invention and to enable others skilled in the art to utilize the invention in such or in other embodiments and with various modifications required by the particular application or use of the invention. It is intended that the appended claims be construed to include alternative embodiments to the extent permitted by the prior art.

What is claimed is:

1. A communication system, comprising:
an identification tag, wherein the identification tag has a known location and provides an identifier;
a mobile device, wherein the mobile device is operable to read the identifier and to transmit the identifier over a communication channel;
a system server, wherein in response to receiving the identifier transmitted by the mobile device the system server is operable to enable a command and control function or a content delivery function.

2. The system of claim 1, further comprising:
an output device, wherein the system server enables control of the output device by the mobile device.

3. The system of claim 1, further comprising a communication system app running on the mobile device, wherein the identifier is forwarded to the system server by the communication system app.

4. The system of claim 1, further comprising:
a communication device, wherein the identifier provided by the identification tag is communicated to the mobile device by the communication device.

5. The system of claim 4, wherein the communication device communicates the identifier over a radio frequency communication channel.

6. The system of claim 4, wherein the communication device communicates the identifier as an image that is captured by a camera included as part of the mobile device.

7. The system of claim 4, wherein the communication device communicates the identifier as a series of sounds that is captured by a microphone included as part of the mobile device.

8. The system of claim 4, wherein the communication device includes at least one of a remote control unit, a set top box, a television, or a network access point.

9. The system of claim 1, wherein in response to determining that the mobile device is in an authorized location, the system server enables delivery of content to the mobile device.

10. The system of claim 1, wherein in response to determining that the mobile device is in an authorized location and that the mobile device is associated with an authorized user, the system server enables delivery of content to the mobile device.

11. A communication system, comprising:
an identification tag;
a mobile device, including:
memory, the memory containing a communication app;
a processor, the processor operable to run the communication app;
an input device;
an output device;
a communication interface, wherein the mobile device is operable to receive an identifier provided by the identification tag through one of the input device and the communication interface, and to transmit the identifier through the communication interface;
a server system, including:
memory, the memory containing a communication application;
a processor, the processor operable to run the communication application;
a communication interface, wherein the server system is operable to receive the identifier transmitted by the mobile device, to validate the identifier, and to authorize the mobile device to perform a command and control operation or to receive content in response to successfully validating the identifier.

12. The system of claim 11, further comprising:
a communication device, wherein the identification tag provides the identifier to the communication device, and wherein the communication device delivers the identifier to the mobile device.

13. The system of claim 11, further comprising:
a property management system, wherein the property management system provides information identifying the mobile device or information held by the mobile device to the server system, and wherein the server system is operable to validate the identifier, and to authorize the mobile device to perform a command and control operation or to receive content in response to successfully validating the information provided by the property management system.

14. The system of claim 11, wherein in response to successfully validating the identifier the mobile device is authorized to perform a command and control operation and to receive content.

15. A method for providing content, comprising:
providing an identifier from an identification tag to a mobile device;
providing the identifier from the mobile device to a system authority;
determining by the system authority whether the identifier is associated with a location that is authorized for a specified operation;
in response to the determining that the identifier is associated with a location that is authorized for the specified operation, authorizing the specified operation.

16. The method of claim 15, further comprising:
providing information regarding a status of a user from a management system to the system authority, wherein the specified operation is only authorized if the information regarding the status of the user validates the user for the specified operation.

17. The method of claim 15, wherein the specified operation includes authorizing the delivery of content to the mobile device.

18. The method of claim 17, wherein the delivery of content is authorized, the method further comprising;
after authorizing the delivery of content, determining that the mobile device has left the authorized location, and discontinuing the delivery of content.

19. The method of claim 18, wherein determining the mobile device has left the authorized location includes determining that the mobile device is no longer in contact with a communication device that earlier provided the identifier to the mobile device.

20. The method of claim 19, wherein the identifier is an identifier of at least one wireless access point.
